(19) United States
(12) Patent Application Publication
(10) Pub. No.: US 2013/0160502 A1
(43) Pub. Date: Jun. 27, 2013

(54) LOCK FOR ELECTRONIC DEVICE

(71) Applicant: Meir Avganim, Gealya (IL)

(72) Inventor: Meir Avganim, Gealya (IL)

(21) Appl. No.: 13/721,880

(22) Filed: Dec. 20, 2012

Related U.S. Application Data
(60) Provisional application No. 61/579,894, filed on Dec. 23, 2011.

(51) Int. Cl. E05B 73/00

(52) U.S. Cl. CPC E05B 73/0082; E05B 73/0011
USPC 70/15

(57) ABSTRACT

A lock in accordance with an embodiment of the present application includes a housing, a locking tab extending axially from a distal surface of the housing, a pair of ball elements, mounted in the locking tab and laterally movable between an engaging position in which at least a portion of the pair of ball elements extends laterally beyond a lateral surface of the locking tab and a retracted position in which the pair of ball elements remain entirely within the lateral surface of the lateral surface of the locking tab and a locking element axially movable in the housing and movable between a locked extended position in which the locking element moves the ball elements into the engaging position and a retracted positioning which the locking element allows the ball elements to retract into the retracted position.

### CROSS REFERENCE TO RELATED APPLICATIONS

The present application claims the benefit of U.S. Provisional Patent Application No. 61/579,894 filed on Dec. 23, 2011; which is incorporated herein by reference in its entirety.

### BACKGROUND OF THE INVENTION

1. Field of the Disclosure

The present invention relates to a lock for use is securing a tablet type computer or other similar electronic device.

2. Related Art

With the increased use of portable electronic devices such as tablet computers, laptops, etc. there is an increasing need to be able to secure such devices. There are a variety of locking systems on the market that are used to secure laptop computers, many of which utilize a lock that engages a slot formed in the body of the laptop.

Tablet type computers are somewhat new to the market, and thus, effective locks for these devices are still developing. Tablet type computers typically include a securing slot, formed into the housing of the tablet with an opening that is typically five millimeters high and five millimeters wide or round with a 5 mm diameter. The interior of the slot is slightly larger, such that it may accommodate a locking tab or element.

Accordingly, it would be desirable to provide a lock that is suitable for use with a tablet type computer and preferably compatible with the slot formed therein.

### SUMMARY OF THE INVENTION

It is an object of the present invention to provide a lock suitable for use in securing a tablet type computer via a slot formed in the body of the device.

A lock in accordance with an embodiment of the present application includes a cylindrical housing, a locking tab extending axially from a distal surface of the housing, a pair of ball elements, mounted in the locking tab and laterally movable between an engaging position in which at least a portion of the pair of ball elements extends laterally beyond a lateral surface of the locking tab and a retracted position in which the pair of ball elements remain entirely within the lateral surface of the lateral surface of the locking tab and a locking element axially movable in the housing and movable between a locked extended position in which the locking element moves the ball elements into the engaging position and a retracted positioning which the locking element allows the ball elements to retract into the retracted position.

A lock in accordance with another embodiment of the present application includes a body having a substantially planar and rectangular shape, a locking tab extending from a distal end of the body, a pair of ball elements, mounted in the locking tab and laterally movable between an engaging position in which at least a portion of the pair of ball elements extends laterally beyond a lateral surface of the locking tab and a retracted position in which the pair of ball elements remain entirely within the lateral surface of the lateral surface of the locking tab, and a locking element axially movable in the housing between a locked retracted position in which the locking element moves the ball elements into the engaging position and an extended, unlocked positioning which the locking element allows the ball elements to retract into the retracted position.

### BRIEF DESCRIPTION OF THE DRAWINGS

FIG. 1 is a cross-sectional view of a cylindrical lock in accordance with an embodiment of the present application in a locked state;

FIG. 2 is a cross-sectional view of the lock of FIG. 1 in an unlocked state;

FIG. 2A illustrates an alternative embodiment of the lock of FIG. 1;

FIGS. 2B, 2C and 2D show alternatively shaped locking tabs.

FIG. 3 is an exemplary embodiment of a flat or planar lock in accordance with an embodiment of the present application;

FIG. 4 is an illustration of the lock of FIG. 3 with a cover thereof removed;

FIG. 5 is a cross-sectional view of the lock of FIG. 3 is a locked state;

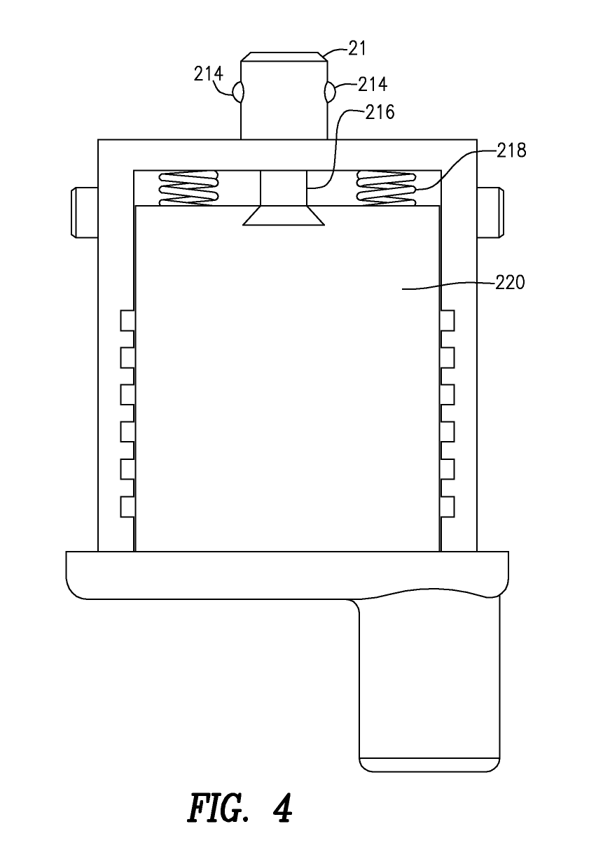

FIG. 6 is a cross-sectional view of the lock of FIG. 3 in an unlocked state;

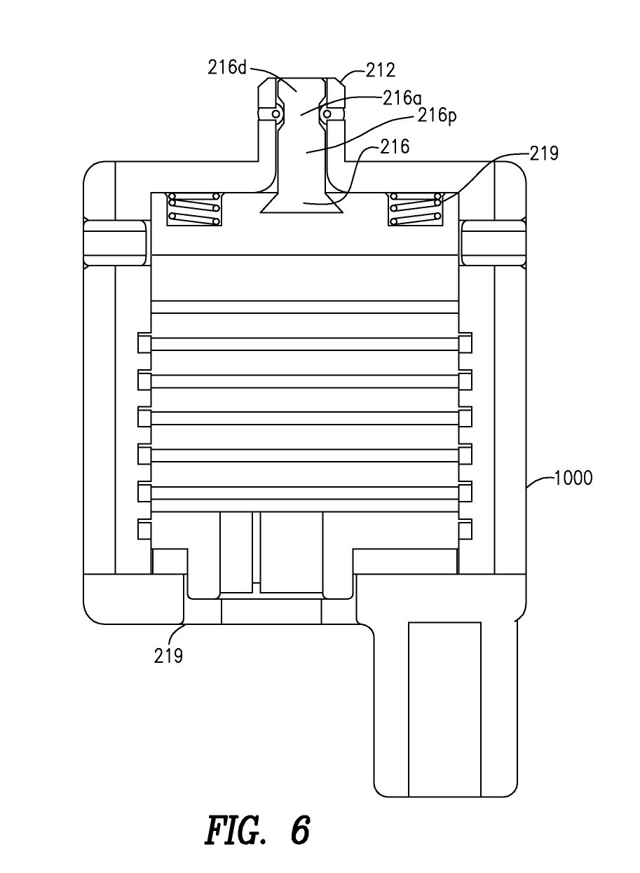

FIGS. 7, 7A and 8 show alternatives, comprising differently shaped securing slots;

FIG. 9 shows a differently formed security slot;

FIGS. 10A and 10B show the locking tab for the security slot of FIG. 9;

FIG. 11 shows the locking tab, together with the overall lock corresponding to FIG. 10; and

FIGS. 12A and 12B show the form and certain dimensions related to forming a security slot.

### DETAILED DESCRIPTION OF EMBODIMENTS OF THE INVENTION

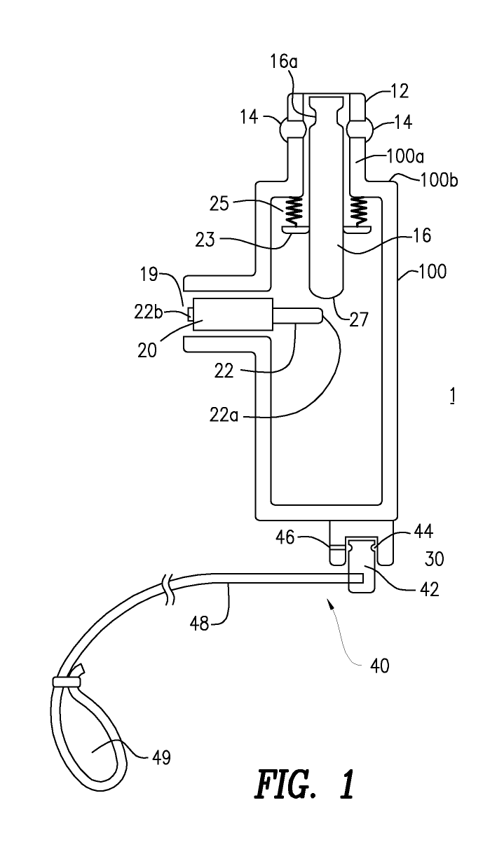

A lock 1 in accordance with an embodiment of the present disclosure is illustrated in FIG. 1. The lock 1 includes a housing 100 with a locking tab 12 that extends from a distal end thereof and is received in a slot formed in an electronic device. The slot is preferably configured and sized to accommodate the tab 12. In a preferred embodiment, the slot is approximately 5 mm by 5 mm in size and the tab 12 is sized and shaped to fit into the 5 mm by 5 mm opening in the slot. An inner area of the slot is preferably slightly larger than the slot opening. The tab 12 and housing 100 are preferably substantially cylindrical in shape. The tab 12 extends a predetermined amount into the slot of the device to be secured.

The tab 12 includes at least two, and optionally additional ball elements 14 that are mounted in the tab 12 such that they are movable laterally between an engaging position and a retracted position. In the engaging position, the ball elements 14 extend outward from the sides of the tab 12 to increase the circumference of the tab 12. As a result of this increased circumference, the tab 12 cannot be removed from the slot in the item being secured. The larger circumference of the tab 12 when the ball elements 14 are in the engaging position is accommodated by the slightly larger inner area of the slot.

In the retracted position, the ball elements 14 retract back into the tab 12. The tab 12 can then slide out of the slot. The movement of the ball elements 14 is preferably controlled via the position of the locking element 16. The locking element 16 is preferably movable in an axial direction, substantially perpendicular to the direction of movement of the ball elements 14, between an extended, locked position and a retracted, unlocked position. The locking element 16 includes a narrow bridge element 16a that extends between the distal end 16d and the proximal end 16p thereof. When the locking element 16 is in the extended, locked position, the wider, proximal portion 16p of the element 16 is aligned with the ball elements such that the ball elements 14 are pressed out to the engaging position.

When the locking element 16 is in the retracted, unlocked position, the narrow bridge element 16a is aligned with the ball elements 14. As a result, the narrow bridge element 16a allows the ball elements 14 to move inward in the retracted position.

Elaborating on the foregoing, when the rod 22 is in the retracted position, the spring 25, which is normally compressed between the ledge 23 of the locking element 16 and an interior surface of the housing 100, pushes the element 16 downwardly to a position where the ball elements can be compressed inward and the lock removed from the security slot. Conversely, when the lock assembly 20 is operated to push the rod 22 axially outwardly, its chamfered surface 22a (FIG. 1) engages the corresponding chamfered surface 27 of the element 16, pushing it axially until its shoulder engages the ball elements 14 and so presses them into the locked position shown in FIG. 1. The element 22b can be a key operated mechanism that is utilized to slide the rod 22 outwardly and inwardly or a push button or the like, in a manner well known in the prior art.

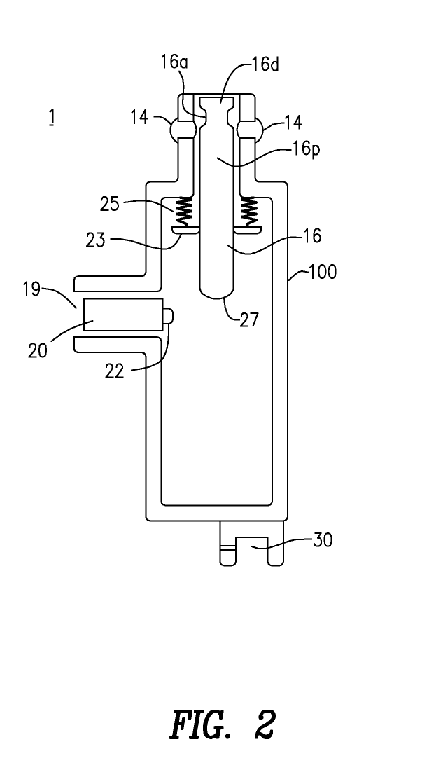

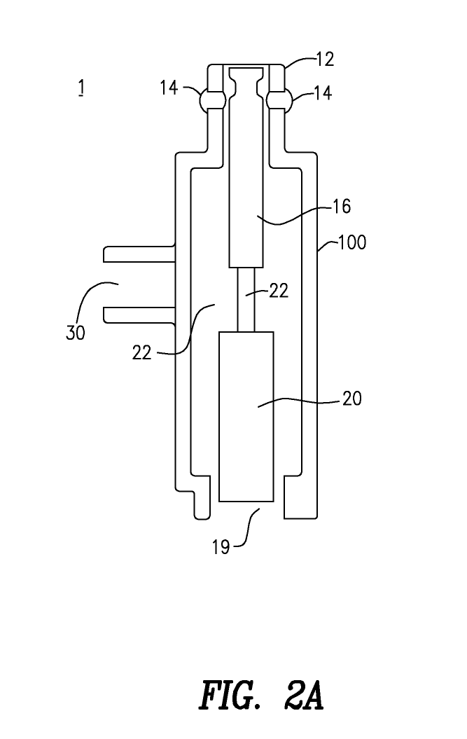

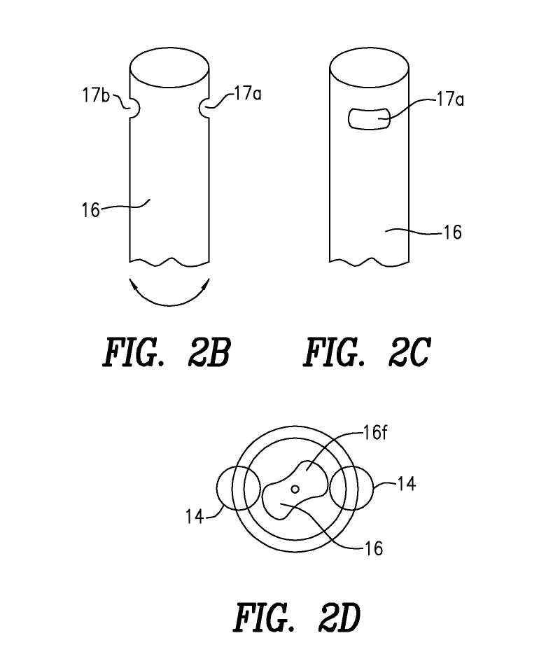

In one embodiment, a cylindrical lock assembly 20 is provided positioned in a side of the housing 100. The cylindrical lock assembly 20 is preferably a push cylinder type lock assembly, which is commonly known. In the assembly 20, a cylindrical rod 22 is slidable between a locked position in which the rod extends axially from a distal end of the assembly (See FIG. 1). The rod 22 holds the locking element 16 in the locked, extended position. When unlocked, the rod 22 retracts into the assembly 20 (See FIG. 2). This allows the locking element 20 to retract such that the ball elements 14 retract inward. The locking element 16 and the rod 20 may be biased to return to the retracted positions, respectively. A cylindrical key (not shown) is used to unlock the assembly 20 and allow the rod 22 to retract in a conventional manner.

A cable receptacle 30 is also provided in the housing 100 to secure a cable to the lock 1. The cable is used to secure the lock 1 to an immovable, or at least difficult to move object such that the electronic device may be secured in place. The cable assembly (FIG. 1) may include a block 42 which is received in the cavity of the cable receptacle 30 with detents 44 which can be engaged by a screw 46 which, when tightened, enters the detent and prevents the block 42 from being removed, while allowing it to rotate in the receptacle 30. The cable 48 is secured at one distal end thereof to the block 42 and includes at the other end, in well known manner, a loop 49 which is large enough to pass therethrough the entire housing 100, to thereby secure the object that has the security slot formed therein to an immovable object such as a chair, a desk, and the like.

The lock assembly 20 may alternatively be positioned at a proximal end of the housing 100, if desired. See FIG. 2A. In this embodiment, the rod 22 pushes the lock element 16 into the extended, locked position and retracts to allow the lock element to return to the retracted, unlocked position. The cable receptacle 30 may be provided on a side of the housing 100.

Referring to FIGS. 2B and 2C, in accordance with another embodiment, the locking element 16 comprises detents 17a and 17b on opposed sides, which are always registered with the location of the ball elements 14. The locking element 16 is designed to be rotated 90° between two positions by a lock cylinder, for example, of the type shown in FIG. 2A. Therefore, when the locking element is in the position shown in FIG. 2C, the ball elements would be pushed out into the locked position. Conversely, when the detent 17a is registered with the ball element, the lock 1 is in the unlocked position.

Yet another embodiment (FIG. 2D) shows the locking element 16 to have a distal end shaped like a cam which is rotatable between one position where the circumferential surface pushes the ball elements outwardly into a locked position and another position where detents are defined to permit the lock to be retrieved from the security slot.

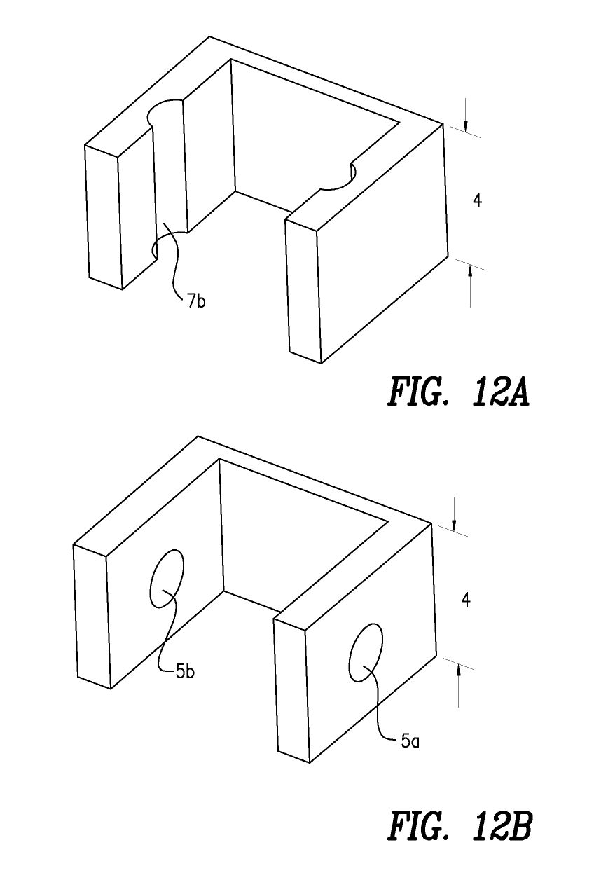

In general, the housing 100 (FIG. 1) has a narrowed section 100a with a shoulder 100b which defines the depth of penetration of the housing section 100a into the security slot. This allows the ball elements 14 to register precisely, where the location of corresponding detents 5a, 5b or 7a, 7b, as shown in FIGS. 12B and 12A.

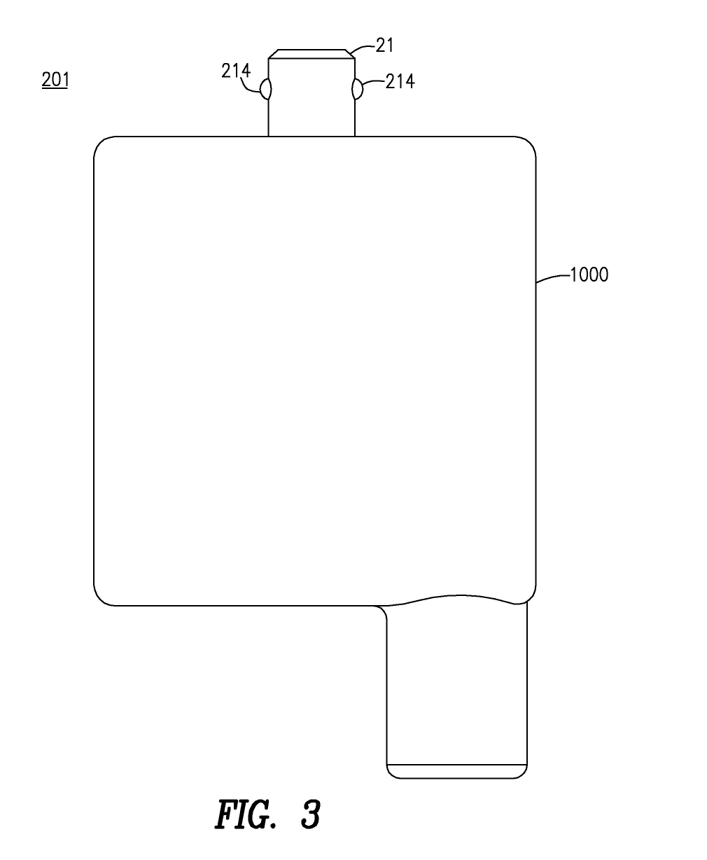

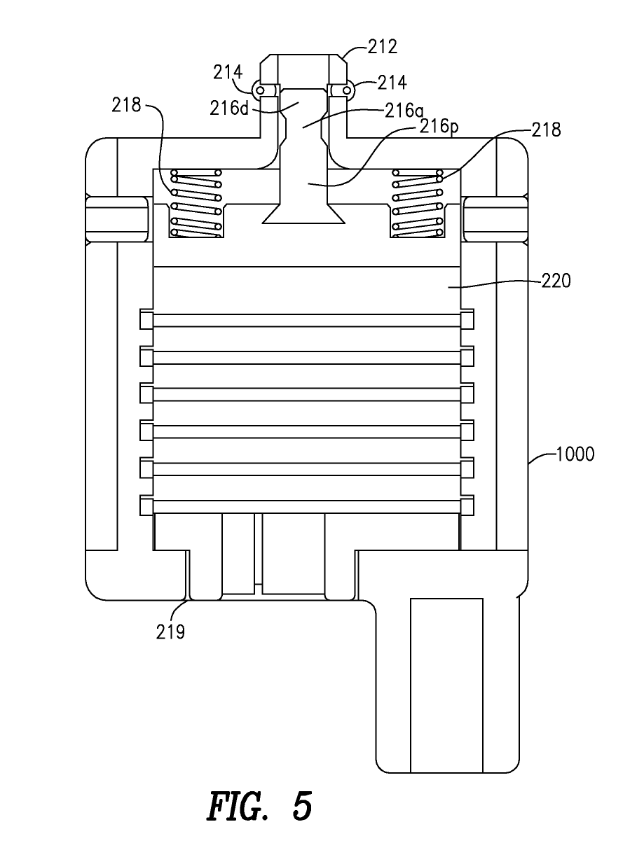

FIG. 3 illustrates another embodiment of a lock 201 that may be used to secure an electronic device. The lock 201 preferably includes a housing 1000 with a substantially flat and rectangular shape. The housing 1000 includes distally extending tab 212 similar to the tab 12 discussed above and including ball elements 214 that operate in substantially the same manner as the ball elements 14 described above. The movement of the ball elements 214 is controlled by the locking element 216 (See FIG. 4).

In this embodiment, however, the locking element 216 is in the locked position when it is retracted, such that the wider distal end 216d of the locking element 216 forces the ball elements 214 outward into the engaging position. In the unlocked position, the locking element 216 is extended such that the narrow bridge portion 216a is aligned with the ball elements 214 and the ball element 214 retract inward to the retracted position.

A lock assembly 220 is connected to the locking element 216. The locking element 216 is biased into the retracted position via spring 218 with the ball elements 214 in the engaging position. In order to move the locking element 216 into the extended, unlocked position to retract the ball elements 214, a key is required. A key opening 219 is formed in a proximal wall of housing 1000. The key, is inserted and releases pins in the lock assembly 20 that engage the housing 1000 and pushes the assembly 220 axially forward such that the ball elements 214 retract. In the retracted position, the lock 201 is removable from the device to which it is attached.

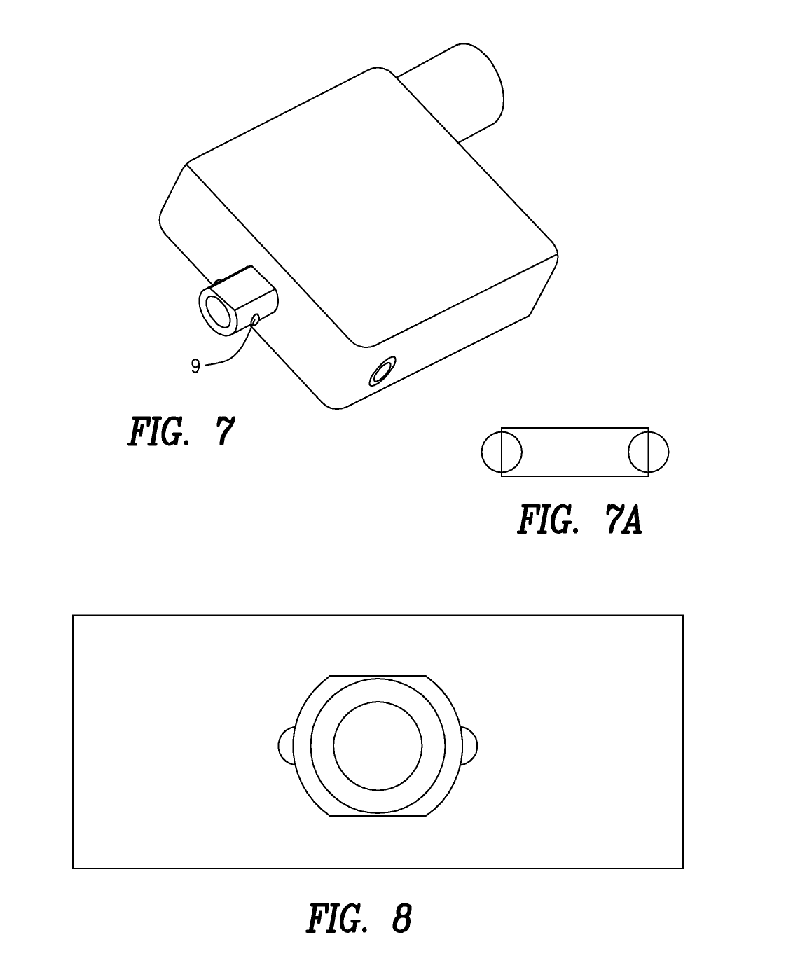

FIG. 7 shows the neck 9 (corresponding to the housing 100a in FIG. 1), which is inserted into the security slot. It is shown with its top and bottom shape to provide a more rectangular shape. Indeed, the neck can be substantially rectangular or even square, as shown in FIG. 7A. See also FIG. 8.

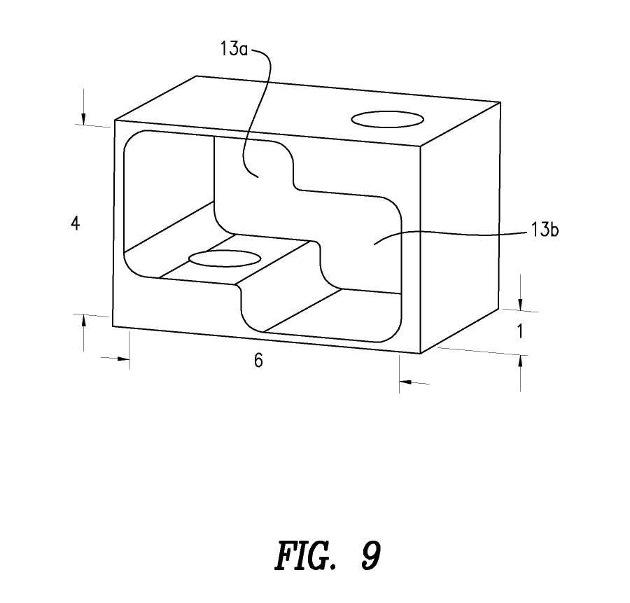

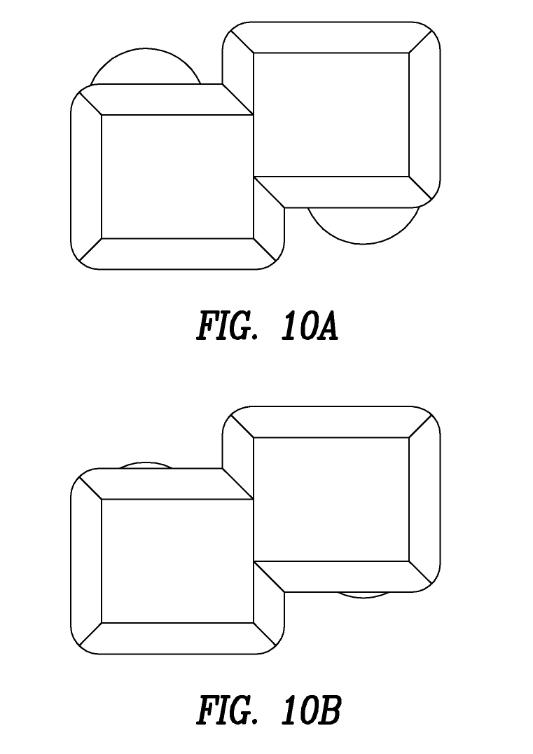

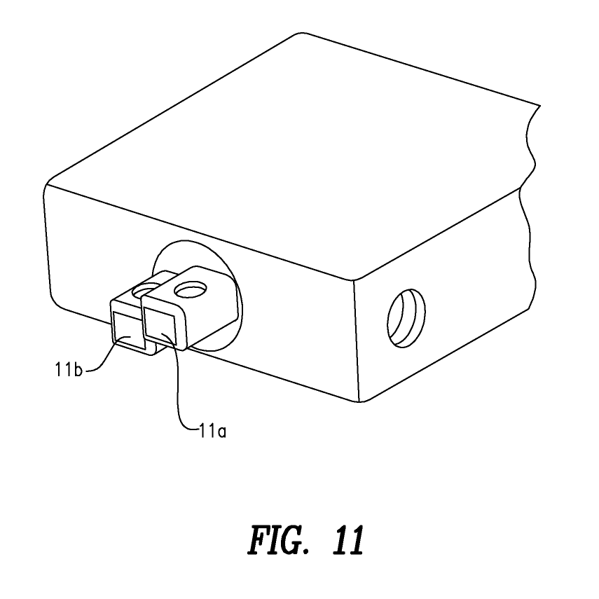

Referring to FIG. 11, a different lock neck is provided, arranged on two planes. It consists of a portion 11a housing one ball element and 11b housing another ball element. In use, this type of configuration works with a security slot shaped as shown in FIG. 9, with the portion 11a fitting in the opening 13a and the portion 11b fitting in the security slot portion 13b. The overall dimension of the security slot can be fabricated not to exceed 4×6 mm, with about a thickness of 1 mm or so for receiving the ball element at the left and at the right, as shown. The ball elements are shown in their locked position (FIG. 10A) and retracted position (FIG. 10B). As before, a locking element which is shaped complementarily to the structure of the neck portions 11a and 11b can be retracted in and out of an interior space (not shown) to push the ball elements out or to allow them to fall back into the neck portions 11a and 11b when that locking element is withdrawn.

Thus the lock 1, 201 of the present application provides an easy to use and simple locking mechanism for use in securing a tablet type computer.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A lock comprises:
a housing;
a locking tab extending axially from a distal surface of the housing;
ball elements, mounted in the locking tab and laterally movable between an engaging position in which at least a portion of the ball elements extends laterally beyond a lateral surface of the locking tab and a retracted position in which the ball elements remain retracted within the lateral surface of the lateral surface of the locking tab; and
a locking element axially movable in the housing and movable between a locked extended position in which the locking element moves the ball elements into the engaging position and a retracted positioning which the locking element allows the ball elements to retract into the retracted position.

2. The lock of claim 1, wherein the locking element includes a narrow bridge element connecting wider distal portion and wider proximal portion.

3. The lock of claim 1, wherein the narrow bridge element is aligned with the ball elements when the locking member is in the retracted position and the wider proximal portion is aligned with the balls to push then into the engaging position when the lock element is in the extended locked position.

4. The lock of claim 3, further comprising a lock assembly operatively connected to the lock element to control the position of the lock element.

5. The lock of claim 4, wherein the lock assembly includes a rod, axially movable in the lock assembly between a locked position in which the rod extends from a proximal end of the lock assembly and holds the lock element in the extended position and an unlocked position wherein the rod retracts into the lock assembly such that the lock element retracts.

6. A lock comprising:
a body having a substantially planar, and flat shape;
a locking tab extending from a distal end of the body;
ball elements, mounted in the locking tab and laterally movable between an engaging position in which at least a portion of the ball elements extends laterally beyond a lateral surface of the locking tab and a retracted position in which the ball elements remain entirely within the lateral surface of the lateral surface of the locking tab; and
a locking element axially movable in the housing between a locked retracted position in which the locking element moves the ball elements into the engaging position and an extended, unlocked positioning which the locking element allows the ball elements to retract into the retracted position.

7. The lock of claim 6, wherein the locking element includes a narrow bridge element connecting wider distal portion and wider proximal portion.

8. The lock of claim 1, wherein the narrow bridge element is aligned with the ball elements when the locking member is in the extended position and the wider distal portion is aligned with the balls to push then into the engaging position when the lock element is in the retracted, locked position.

9. The lock of claim 8, further comprising a lock assembly operatively connected to the lock element to control the position of the lock element.

10. The lock of claim 8, wherein the lock assembly is biased into a locked position in which the locking element is retracted and is movable into an unlocked position in which the locking element is extended with a key.
